(19) United States
(12) Patent Application Publication
(10) Pub. No.: US 2010/0205327 A1
(43) Pub. Date: Aug. 12, 2010

(54) INFORMATION PROCESSING APPARATUS, PROGRAM CONTROL METHOD, AND COMPUTER PROGRAM PRODUCT

(76) Inventor: Takanari HAMASAKI, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/691,206

(22) Filed: Jan. 21, 2010

(30) Foreign Application Priority Data
Feb. 10, 2009 (JP) 2009-028616

(51) Int. Cl. G06F 3/00

(52) U.S. Cl. 710/16

(57) ABSTRACT

A program starting unit starts a program stored in an external recording medium connected to an external recording medium connecting unit. An external device connection detecting unit detects a connection of an external device to an external device connecting unit. A first information acquiring unit acquires first information related to the external device connected to the external device connecting unit. A second information acquiring unit acquires second information related to an external device that can be utilized by executing the program. A determining unit determines whether the external device can be utilized, by comparing the first information and the second information. When it is determined that the external device can be utilized, a control unit controls the external device. On the other hand, when it is determined that the external device cannot be utilized, an informing unit informs that the external device cannot be utilized to a user.

### CROSS-REFERENCE TO RELATED APPLICATIONS

The present application claims priority to and incorporates by reference the entire contents of Japanese Patent Application No. 2009-028616 filed in Japan on Feb. 10, 2009.

### BACKGROUND OF THE INVENTION

1. Field of the Invention

The present invention relates to an information processing apparatus, a program control method, and a computer program product.

2. Description of the Related Art

In recent years, it is general to have a configuration that can dynamically connect various types of devices by using a general-purpose interface. The typical example of such a general-purpose interface is USB (Universal Serial Bus). Now, the development and management of USB specification are performed by USB Implementers Forum, Inc. (USB-IF). The details of USB specification can be found in “Universal Serial Bus Specification Revision 2.0”, [online], USB Implementers Forum, Inc., [Jan. 9, 2009 retrieval], Internet <URL: http://www.usb.org/developers/docs/usb_{—}20_{—}122208.zip> (Non-Patent Document 1). Various USB devices (for example, an input device such as a USB keyboard or mouse, an output device such as a printer, and a memory storage such as a hard disk or a USB memory (for example, a flash device or a flash memory that has a USB port, generally portable)) based on the USB specification becomes widespread around the field of a personal computer.

A device having various kinds of functions as exemplified above is present as a USB device. When a USB host (PC) that controls a USB device detects the connection of a USB device having a new function, the USB host installs a control program (control software) such as a function peculiar to the USB device or a driver peculiar to the USB device in a system program (system software). In this way, it is general that the USB device can be used in the USB the host.

To be able to use the USB device, it is necessary to install a control program as described above. There is a problem in that it takes a lot of trouble over acquiring data (control program) required for installation. As technology relevant to such a problem, there are known technologies disclosed in Japanese Patent Application Laid-open No. 2002-373144 (Patent Document 1), Japanese Patent Application Laid-open No. 2008-139916 (Patent Document 2), and Japanese Patent Application Laid-open No. 2000-194645 (Patent Document 3).

Patent Document 1 discloses a technology for removing a trouble by holding a USB device driver (control program) in a USB device and directly acquiring the USB device driver required for installation from the USB device.

Patent Document 2 discloses substantially the same technology as that of Patent Document 1, that is, a technology for holding a driver (control program) in an USB device and holding an installation flag indicative of the installation status of the driver in a PC (USB host) to install the driver within the USB device when the installation of the driver is required.

Patent Document 3 discloses substantially the same technology as those of Patent Documents 1 and 2, that is, a technology for previously storing control software (a driver, a utility, and or like) in a USB device and transferring the control software from the USB device to a host.

The technologies disclosed in Patent Documents 1 to 3 can be a valid technology when a control program (control software) can be added to (installed in) a system program (system software) of a USB host (PC). However, in recent years, a general-purpose interface such as USB is also used for an installation device such as MFP (Multifunction Printer) or LP (Laser Printer) in addition to the field of PC. In such an installation device, a system program can be stored in ROM that cannot be rewritten and additionally recorded in many cases. Therefore, because the control program cannot be added to (installed in) the installation device, the technologies disclosed in Patent Documents 1 to 3 are not valid. When a USB device is connected to such an installation device, the USB device can be used only when a function peculiar to the USB device or a control program peculiar to the USB device is preliminarily incorporated into the installation device. The USB device cannot be used when the control program is not preliminarily incorporated into the installation device.

From circumstances as described above, it is desirable that an apparatus of using a general-purpose interface such as USB informs a user of whether a device connected thereto can be used. Moreover, “USB-IF Embedded Host Compliance Plan”, Revision 1.0, August 2006, [online], USB Implementers Forum, Inc., [Jan. 9, 2009 retrieval], Internet <URL: http://www.usb.org/developers/docs/EH_Compliance_v1_{—}0.pdf> (Non-Patent Document 2) describes that a “No Silent Failure” function for informing a user of whether a connected device can be used is provided in an installation device. To realize the function, it is necessary that the installation device uniquely determines whether the connected USB device can be used and then determines whether the determination result is reported to the user.

On the other hand, there is proposed a technology that an apparatus that cannot rewrite or additionally write a system program of MFP or LP can easily add a function enhancement program. Japanese Patent Application Laid-open No. 2004-046804 (Patent Document 4) discloses a technology for holding a function enhancement program in an attachable/detachable external storage device such as SD card (registered trademark) and detecting the attachment/detachment of the external storage device to automatically start the function enhancement program. By using the technology disclosed in Patent Document 4, an external connection device that cannot be conventionally used in an apparatus such as MFP or LP can be used in some cases. For example, a digital camera cannot be conventionally used even when the digital camera is connected to an apparatus such as MFP or LP. However, by applying the technology disclosed in Patent Document 4 to an apparatus such as MFP or LP, a program related to “PictBridge” disclosed in “PictBridge-CIPA”, [online], limited-liability intermediate corporation camera & imaging products association, [Jan. 9, 2009 retrieval], Internet <URL: http://www.cipa.jp/pictbridge/indexj.html> (Non-Patent Document 3) as a function enhancement program can be added to the apparatus such as MFP or LP. In this way, there is a case where a printer can directly print images from a digital camera.

If further reviewing an installation device to which an extension program (extension software) can be added by applying the technology disclosed in Patent Document 4, there is a problem in that whether an external connection device connected to a general-purpose interface can be used or not cannot be determined in some cases.

PC or the like can modify or add a system program (system software). PC can hold information indicating whether an external connection device can be used or not by rewriting a system file (for example, a file group generally called “registry” in Windows (registered trademark) of Microsoft Corporation) on a recording medium such as HDD. However, an installation device that cannot rewrite or add a system program cannot hold information indicating whether an external connection device can be used or not. Moreover, it is impossible to know the presence or absence of an extension program until a system program is started. For example, as described above, even if a “PictBridge” program is added once, it is necessary that an installation device again determines that a digital camera cannot be used when the external storage device that holds the “PictBridge” program is removed after that.

### SUMMARY OF THE INVENTION

It is an object of the present invention to at least partially solve the problems in the conventional technology.

According to one aspect of the present invention, there is provided an information processing apparatus including: an external recording medium connecting unit configured to be connected to an external recording medium; an external device connecting unit configured to be connected to a plurality of types of external devices with a predetermined interface; a program starting unit that starts a program stored in an external recording medium connected to the external recording medium connecting unit; an external device connection detecting unit that detects a connection of an external device to the external device connecting unit; a first information acquiring unit that acquires, when the external device connection detecting unit detects the connection of the external device to the external device connecting unit, first information related to the external device connected to the external device connecting unit; a second information acquiring unit that acquires second information related to an external device that can be utilized by executing the program; a determining unit that determines whether the external device connected to the external device connecting unit can be utilized, by comparing the first information and the second information; a control unit that controls, when the determining unit determines that the external device connected to the external device connecting unit can be utilized, the external device connected to the external device connecting unit; and an informing unit that informs, when the determining unit determines that the external device connected to the external device connecting unit cannot be utilized, that the external device cannot be utilized to a user.

Furthermore, according to another aspect of the present invention, there is provided a program control method for an information processing apparatus that includes an external recording medium connecting unit configured to be connected to an external recording medium and an external device connecting unit configured to be connected to a plurality of types of external devices with a predetermined interface. The program control method includes: starting a program recorded in an external recording medium connected to the external recording medium connecting unit; detecting a connection of an external device to the external device connecting unit; first acquiring including acquiring, when the connection of the external device to the external device connecting unit is detected at the detecting, first information related to the external device connected to the external device connecting unit; second acquiring including acquiring second information related to an external device that can be utilized by executing the program; determining whether the external device connected to the external device connecting unit can be utilized by comparing the first information and the second information; controlling, when it is determined that the external device connected to the external device connecting unit can be utilized, the external device connected to the external device connecting unit; and informing including informing, when it is determined that the external device connected to the external device connecting unit cannot be utilized, that the external device cannot be utilized to a user.

Moreover, according to still another aspect of the present invention, there is provided a computer program product including a computer-usable medium having computer-readable program codes embodied in the medium for implementing a program control method for an information processing apparatus that includes an external recording medium connecting unit configured to be connected to an external recording medium and an external device connecting unit configured to be connected to a plurality of types of external devices with a predetermined interface. The program codes when executed cause a computer to execute: starting a program recorded in an external recording medium connected to the external recording medium connecting unit; detecting a connection of an external device to the external device connecting unit; first acquiring including acquiring, when the connection of the external device to the external device connecting unit is detected at the detecting, first information related to the external device connected to the external device connecting unit; second acquiring including acquiring second information related to an external device that can be utilized by executing the program; determining whether the external device connected to the external device connecting unit can be utilized by comparing the first information and the second information; controlling, when it is determined that the external device connected to the external device connecting unit can be utilized, the external device connected to the external device connecting unit; and informing including informing, when it is determined that the external device connected to the external device connecting unit cannot be utilized, that the external device cannot be utilized to a user.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating the configuration of an image forming apparatus (MFP) according to a first embodiment of the present invention;

FIG. 2 is a diagram illustrating a module configuration example of a program stored in a ROM illustrated in FIG. 1;

FIG. 3 is a diagram illustrating a module configuration example of an extension program stored in a card that is inserted into a card slot illustrated in FIG. 1;

FIG. 4A is a diagram illustrating an example of a USB device that can be connected to a USB port illustrated in FIG. 1;

FIG. 4B is a diagram illustrating an example of the USB device that can be connected to the USB port illustrated in FIG. 1;

FIG. 4C is a diagram illustrating an example of the USB device that can be connected to the USB port illustrated in FIG. 1;

FIG. 5 is a diagram briefly illustrating a cooperation relationship between program modules in the image forming apparatus according to the first embodiment;

FIG. 6 is a diagram briefly illustrating the process sequence of each program module at the start of the image forming apparatus according to the first embodiment;

FIG. 7 is a diagram illustrating an example of registration information registered in a table within a USB device monitoring unit illustrated in FIG. 5;

FIG. 8 is a diagram briefly illustrating the process sequence of a program module in the image forming apparatus according to the first embodiment;

FIG. 9 is a diagram briefly illustrating the process of the USB device monitoring unit when the USB device is connected to the USB port illustrated in FIG. 1;

FIG. 10 is a diagram briefly illustrating the process sequence of a program module in the image forming apparatus according to the first embodiment;

FIG. 11 is a diagram briefly illustrating the process sequence of a program module in the image forming apparatus according to the first embodiment;

FIG. 12 is a diagram briefly illustrating the process sequence of a program module in the image forming apparatus according to the first embodiment;

FIG. 13 is a diagram illustrating an example of registration information registered in the table within the USB device monitoring unit illustrated in FIG. 5;

FIG. 14 is a diagram briefly illustrating the process sequence of a program module in an image forming apparatus according to a second embodiment of the present invention;

FIG. 15 is a diagram briefly illustrating a cooperation relationship between program modules in an image forming apparatus according to a third embodiment of the present invention; and

FIG. 16 is a diagram briefly illustrating the process sequence of each program module at the start of the image forming apparatus according to the third embodiment.

### DETAILED DESCRIPTION OF THE PREFERRED EMBODIMENTS

Exemplary embodiments of the present invention will be explained in detail below with reference to the accompanying drawings. The same components have the same reference numbers and their descriptions are omitted.

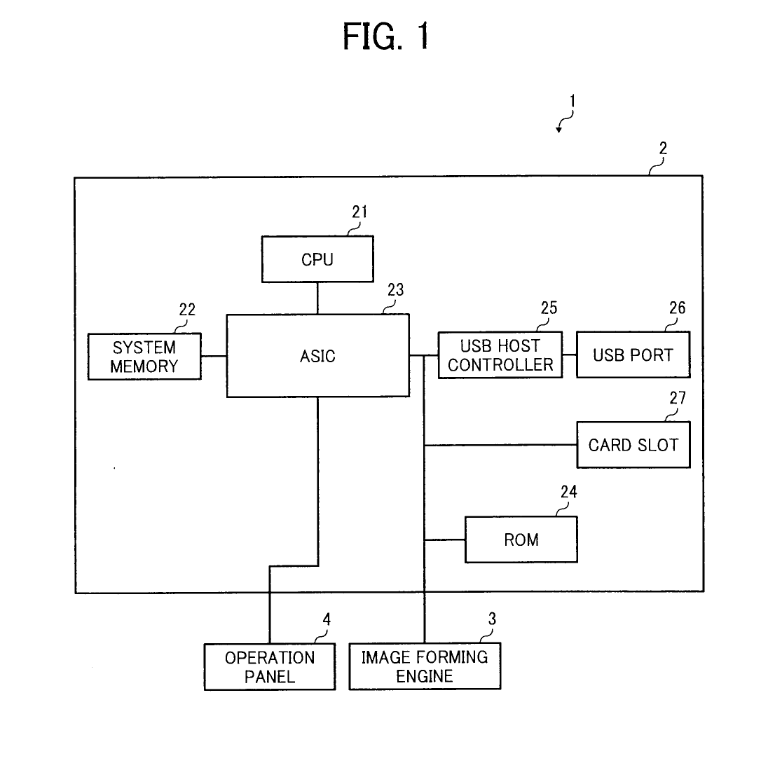

FIG. 1 is a block diagram illustrating the configuration of an image forming apparatus (MFP) 1 according to a first embodiment of the present invention. According to the first embodiment, an information processing apparatus according to the present invention is applied to an image forming apparatus.

The image forming apparatus 1 includes a controller 2, an image forming engine 3, and an operation panel 4. The controller 2 controls the whole of a multifunction product, drawing, communication, and input from the operation panel 4.

The image forming engine 3 is a printer engine. For example, the image forming engine 3 is a monochrome plotter, a one-drum color plotter, a four-drum color plotter, a scanner, or a facsimile unit. In addition, the image forming engine 3 further includes an image processing part such as error diffusion or gamma conversion in addition to a so-called engine part such as a plotter.

The controller 2 includes a CPU 21, a system memory 22, an ASIC (Application Specific Integrated Circuit) 23, a ROM (Read Only Memory) 24, a USB host controller 25, a USB port 26, and a card slot 27.

The CPU 21 performs the total control of the multifunction product and is connected to other components via the ASIC 23.

The ASIC 23 is an image processing IC (Integrated Circuit) having hardware elements for image processing, and has the role of a bridge that connects the image forming engine 3, the operation panel 4, the CPU 21, the system memory 22, the ROM 24, the USB host controller 25, and the card slot 27. The ASIC 23 includes a memory controller that controls the system memory 22, a plurality of DMACs (Direct Memory Access Controllers) that performs the rotation or the like of image data by using hardware logic, and a PCI unit that performs data transfer or the like through a PCI bus between the ASIC and the image forming engine 3. The ASIC 23 is connected to the image forming engine 3, the ROM 24, the USB host controller 25, and the card slot 27 via the PCI bus. The operation panel 4 is directly connected to the ASIC 23.

The system memory 22 is a RAM (Random Access Memory) that is used as a memory for developing a program (software) or data, a memory for drawing in a printer, and the like.

The ROM 24 is a read-out-dedicated memory that is used as a memory for storing a system program (software) or data of the image forming apparatus 1. At starting the image forming apparatus 1, the CPU 21 loads a program stored in the ROM 24 to the system memory 22 and executes the program loaded in the system memory 22.

An external recording medium (for example, SD card (registered trademark) or the like, hereinafter, “card”) that stores an extension program (extension software) is inserted into the card slot 27. When a card that stores an extension program is mounted to the card slot 27, the CPU 21, which executes a system program, automatically executes (starts) the extension program stored in the card. Because a method and a procedure for executing (starting) the extension program stored in the card are not the essentials of the present invention, their descriptions are omitted. As an example of a method for executing (starting) an extension program stored in a card, a technology disclosed in Patent Document 4 can be utilized, for example. However, the present invention is not limited to this. Moreover, the card slot is an exemplification. Therefore, if a device can be connected or mounted to a recording medium that stores an extension program, the device is not limited to the card slot.

The operation panel 4 is a part that performs an interface between the image forming apparatus 1 and a user and includes an LCD (liquid crystal display) and a key switch. The operation panel 4 displays various types of states and operating instructions of the image forming apparatus 1 on the LCD and accepts a key-switch input from the user. When an external connection device connected to the USB port 26 cannot be used, that effect is notified to the user through the operation panel 4. The operation panel is an exemplification. Therefore, if a device can inform a user of the effect, the device is not limited to the operation panel.

Various kinds of USB devices having a connector (plug) defined in a USB specification are connected to the USB port (receptacle) 26. The USB host controller 25 is a host controller that performs data transfer defined in the USB specification between the controller and a USB device connected to the USB port 26. The USB host controller 25 is also a hardware that satisfies the specification of EHCI (Enhanced Host Controller Interface) that is generally known.

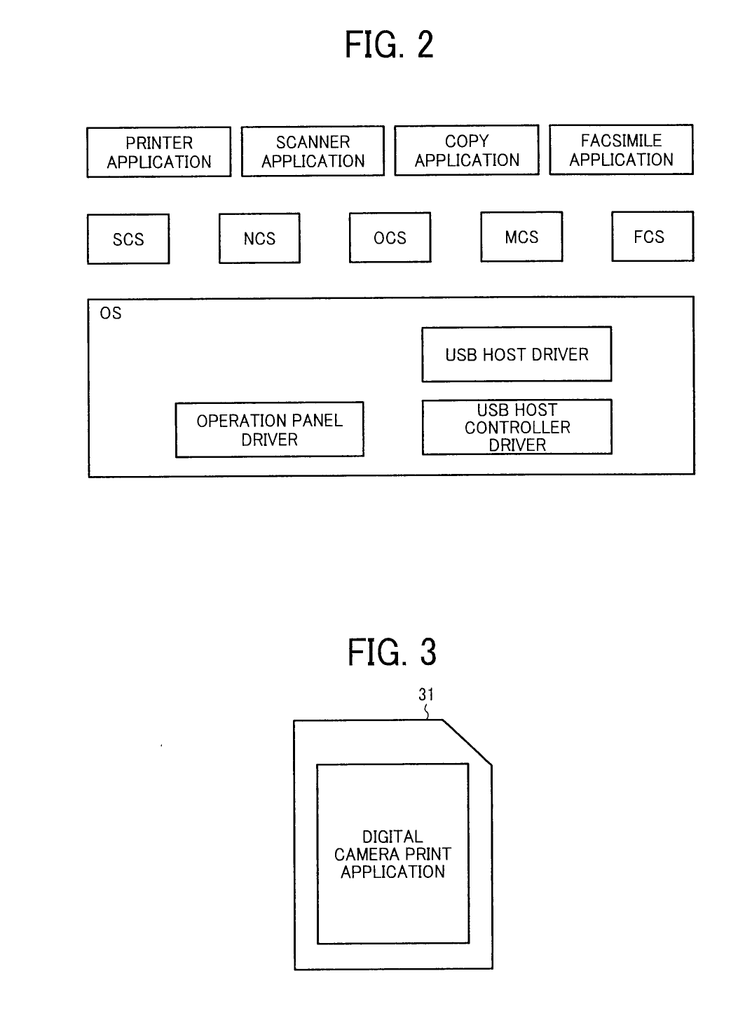

FIG. 2 is a diagram illustrating a module configuration example of a program (software) that is stored in the ROM 24 and is executed by the CPU 21. As illustrated in FIG. 2, an OS (Operating System) includes a USB host controller driver, a USB host driver, an operation panel driver, and the like. The CPU 21 can execute these driver programs to control hardware such as the USB host controller 25 or the operation panel 4.

SCS, NCS, OCS, MCS, and FCS are service control modules and are programs that respectively perform service control of a system and network. Moreover, a printer application program, a scanner application program, a copy application program, and a facsimile application program are application program modules that respectively realize functions (copy and the like) of the image forming apparatus 1. These program modules are stored in the ROM 24 (see FIG. 1).

FIG. 3 is a diagram illustrating an example of a module configuration of an extension program stored in a card that is inserted into the card slot 27. As illustrated in FIG. 3, a digital camera print application program is stored in a card 31. When a digital camera is connected to the USB port 26 of the image forming apparatus 1, the digital camera print application program is an application program that makes the image forming apparatus 1 print an image stored in the digital camera. When the card 31 is inserted into the card slot 27, the digital camera print application program is automatically executed (started) by the CPU 21 that executes a system program. The digital camera print application program is a program module equal to an application program module (a copy application program, a printer application program, and the like) in the program module configuration illustrated in FIG. 2.

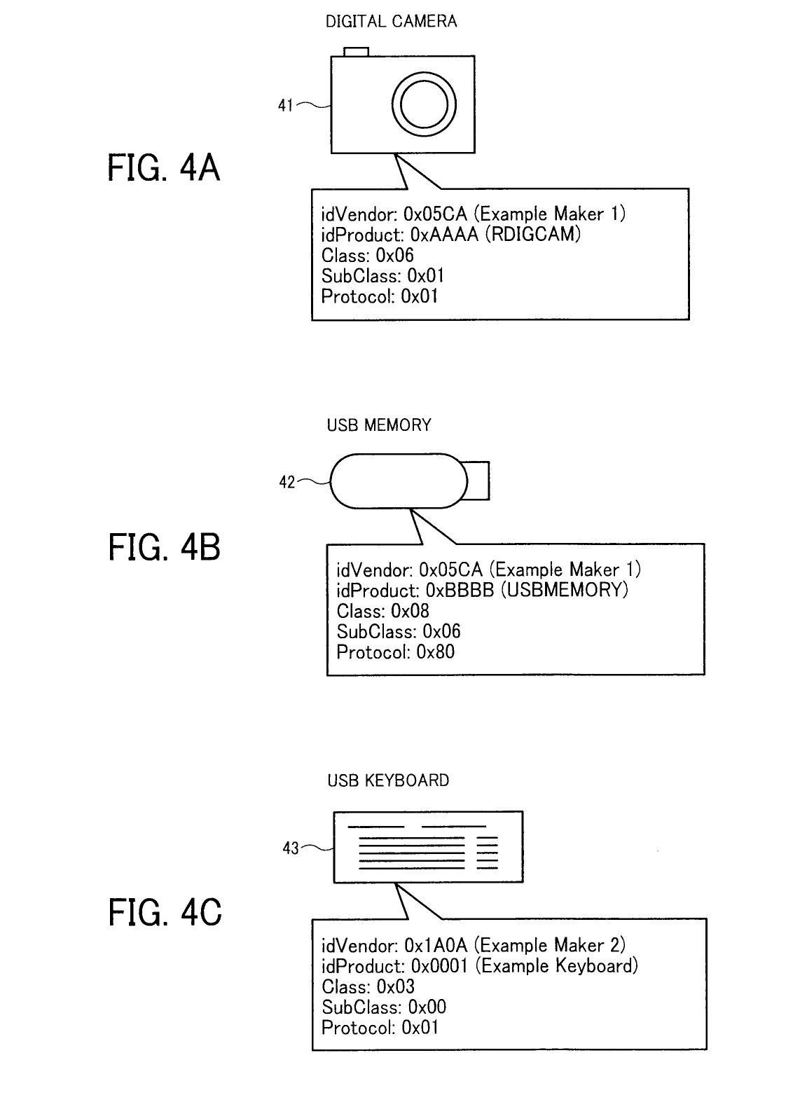

FIGS. 4A to 4C are diagrams illustrating examples of a USB device that can be connected to the USB port 26. Various kinds of devices are present as an USB device. As an example of the USB device, FIG. 4A illustrates a digital camera 41, FIG. 4B illustrates a USB memory 42, and FIG. 4C illustrates a USB keyboard 43. All USB devices store or hold descriptor information defined in a USB specification. The descriptor information includes “Bendor ID (idVendor)” that is the identifier of a manufacturer of a device, data called “product ID (idProduct)” that is the identifier of a product, and data called “Class”, “SubClass”, and “Protocol” that indicates the type (function) of a device. The descriptor information stored (held) in a USB device is decided based on a condition (function and the like) that is peculiar to the USB device. “Class”, “SubClass”, and “Protocol” are decided by “bDeviceClass”, “bDeviceSubClass”, and “bDeviceProtocol” of a standard device descriptor defined in a USB specification or decided by “bInterfaceClass”, “bInterfaceSubClass”, and “bInterfaceProtocol” of a standard interface descriptor defined in the USB specification. Moreover, a procedure by which a USB host acquires descriptor information from a USB device is defined in accordance with the USB specification.

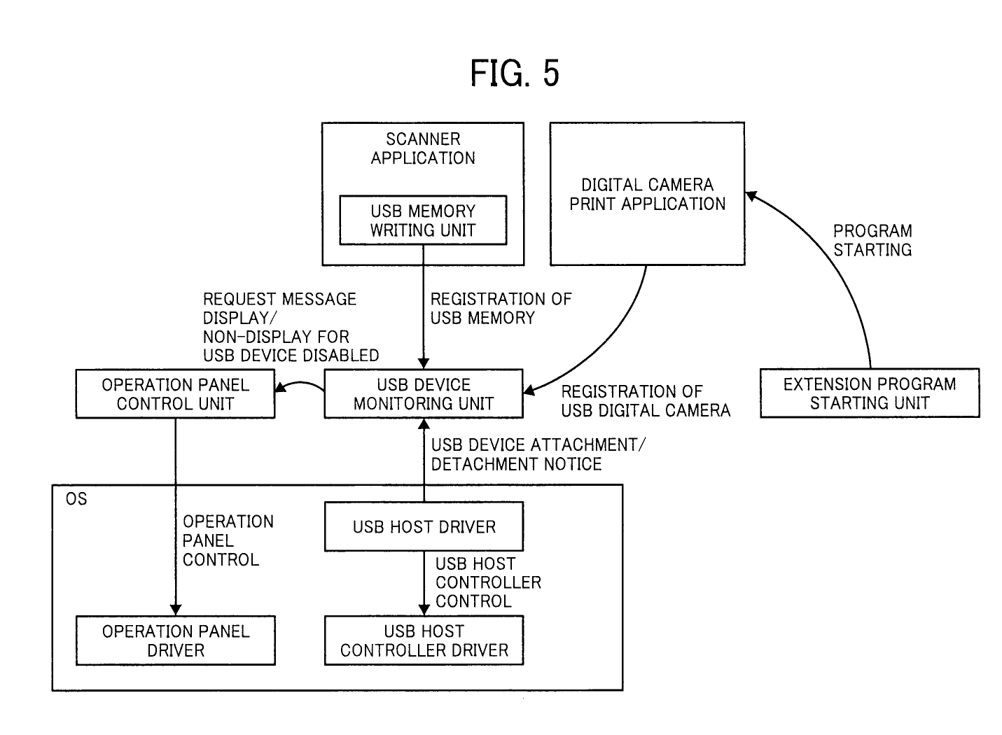

FIG. 5 is a diagram briefly illustrating a cooperation relationship between program modules in the present embodiment. A USB device monitoring unit is a module that monitors attaching or detaching an USB device to or from the USB port 26 of the image forming apparatus 1 and is included as a part of NCS illustrated in FIG. 2.

An operation panel control unit is a module that performs semantic interpretation of message contents to be displayed on the operation panel 4 and input from the operation panel 4 via an operation panel driver. The operation panel control unit is included as a part of OCS illustrated in FIG. 2.

An extension program (extension software) starting unit is a module that starts an extension program (digital camera print application program in the present embodiment) stored in the card 31 and is included as a part of SCS illustrated in FIG. 2.

The scanner application program is a program module that performs a process for a USB memory. The digital camera print application program is a program module that performs a process for a digital camera.

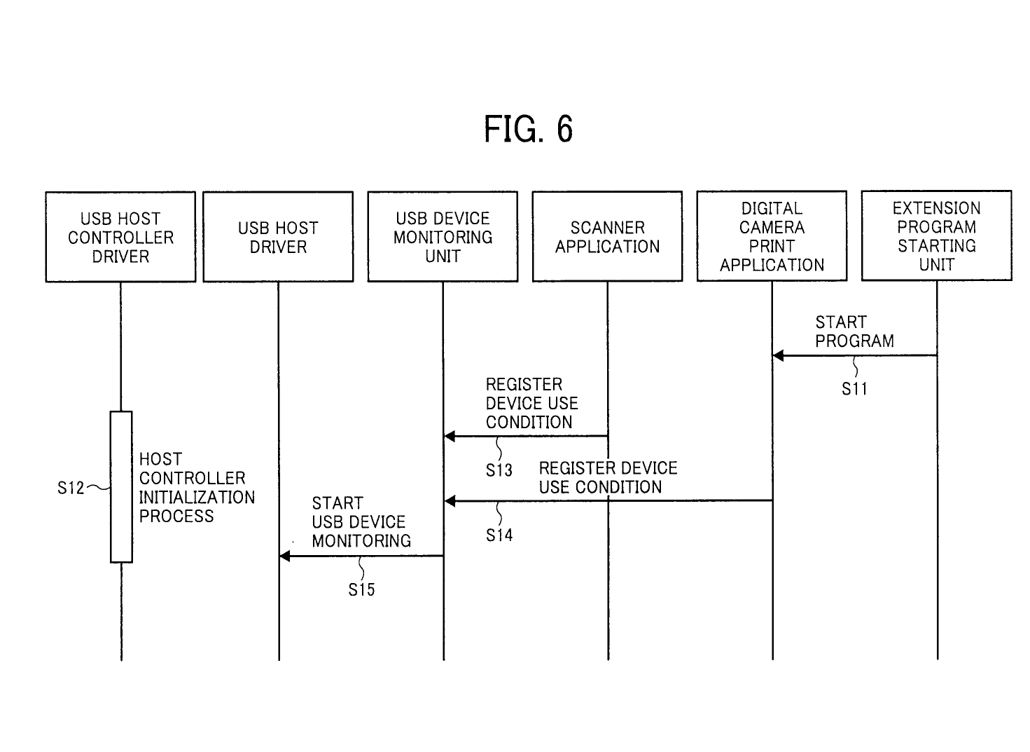

FIG. 6 is a diagram briefly illustrating the process sequence of each program module at the start of the image forming apparatus 1. Each module (driver group, operation panel control unit, USB device monitoring unit, extension program starting unit, and scanner application program) included in the system program is executed (started) by the CPU 21 at the start of the system program.

The extension program starting unit detects the presence of the digital camera print application program stored in the card 31 and starts the digital camera print application program (Step S11). The USB host controller driver performs initialization required for hardware (the USB host controller 25) (Step S12).

The scanner application program registers the condition of a controllable USB device in the USB device monitoring unit (Step S13). According to the present embodiment, the scanner application program can control the USB memory and informs (registers) the USB device monitoring unit of conditions (Class=0x08, SubClass=0x06, and Protocol=0x80) that accord with the USB memory.

Similarly, the digital camera print application program registers the condition of the controllable USB device in the USB device monitoring unit (Step S14). According to the present embodiment, the digital camera print application program can control a digital camera that is defined as an image device and informs the USB device monitoring unit of conditions (Class=0x06, SubClass=0x01, and Protocol=0x01) that accord with the image device.

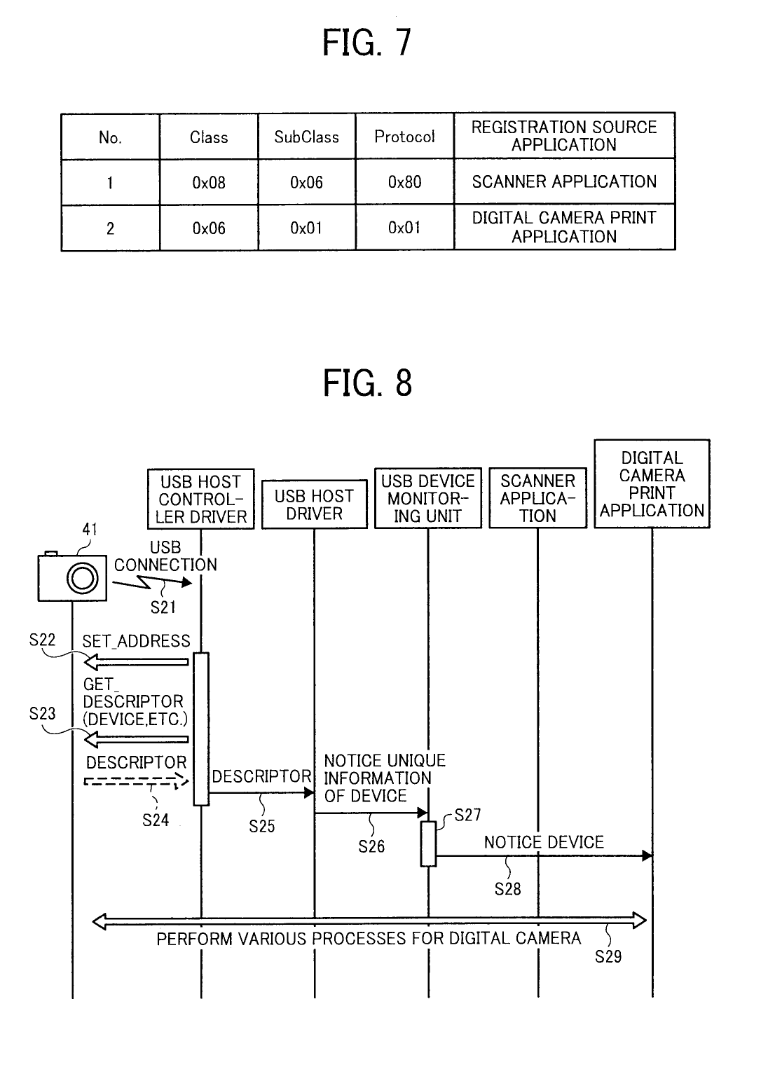

FIG. 7 is a diagram illustrating an example of registration information registered in a table of the USB device monitoring unit in Steps S13 and S14. A first entry of a table illustrated in FIG. 7 is an entry including information related to a USB device (USB memory) registered by the scanner application program in Step S13. A second entry is an entry including information related to a USB device (digital camera) registered by the digital camera print application program in Step S14.

Referring to FIG. 6 again, the USB device monitoring unit starts monitoring the connection of the USB device to the USB port 26 via the USB host driver (and the USB host controller driver) (Step S15).

The above is the brief of the process sequence of each program module at the start of the image forming apparatus 1. Next, it will be explained about the process of each program module when a USB device is connected to the USB port 26, for example, when the digital camera 41 (the example of a USB device that can be used in the present embodiment) is connected to the USB port 26 and when the USB keyboard 43 (the example of a USB device that cannot be used in the present embodiment) is connected to the USB port 26.

First, it will be explained about the process of each program module when the digital camera 41 is connected to the USB port 26. FIG. 8 is a diagram briefly illustrating the process sequence of each program module when the digital camera 41 is connected to the USB port 26.

The connection of a USB device (the digital camera 41 in this example) to the USB port 26 is detected by the USB host controller 25 and is notified to the USB host controller driver (Step S21). Furthermore, the connection is notified to the USB device monitoring unit via the USB host driver. The USB host controller 25 transmits device requests called SET_ADDRESS and GET_DESCRIPTOR to the USB device to acquire descriptor information stored in the USB device (Steps S22 and S23). These device requests are a general standard device request defined in the USB specification.

The USB device transmits descriptor information (including Class=0x06, SubClass=0x01, and Protocol=0x01 in this example) to the USB host controller 25 as responses to these device requests and the USB host controller 25 transmits descriptor information to the USB host controller driver (Step S24). The USB host controller driver transmits descriptor information to the USB host driver (Step S25) and the USB host driver transmits descriptor information (unique information of device) to the USB device monitoring unit (Step S26).

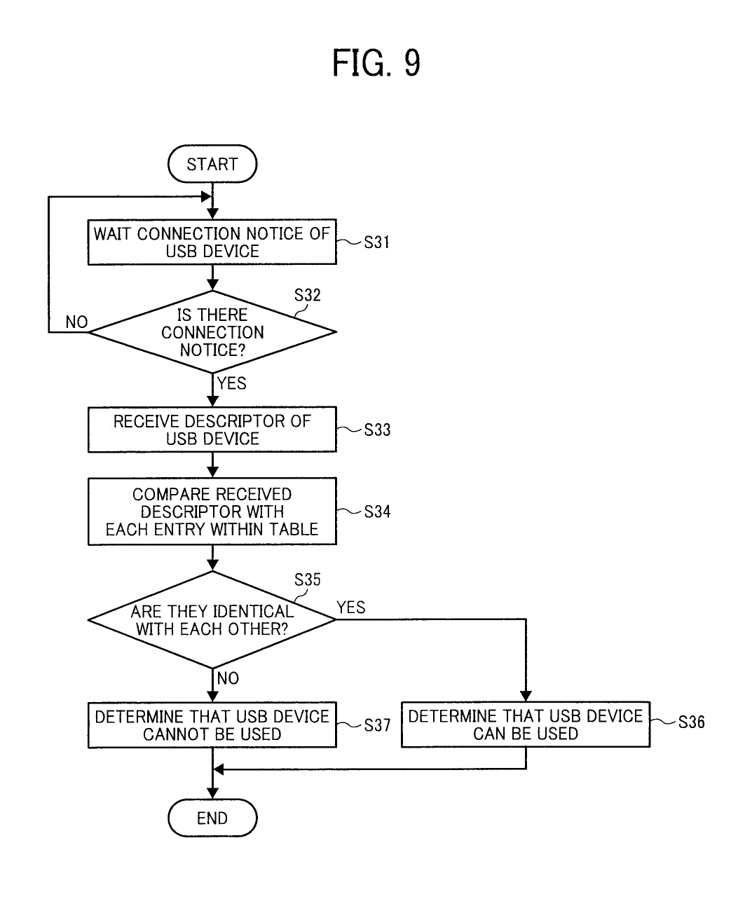

FIG. 9 is a diagram briefly illustrating the process of Step S27 in the USB device monitoring unit when a USB device is connected to the USB port 26. The USB device monitoring unit waits the notice that the connection of a USB device is detected (Step S31). If the effect that the connection of a USB device is detected is not notified (Step S32: No), the USB device monitoring unit continues waiting.

If the effect that the connection of a USB device is detected is notified (Step S32: Yes), the USB device monitoring unit receives the descriptor information of the USB device via the USB host driver and the USB host controller driver (Step S33).

Then, the USB device monitoring unit compares Class, SubClass, and Protocol of the received descriptor information with Class, SubClass, and Protocol of each entry of a table (see FIG. 7) (Step S34). When Class, SubClass, and Protocol of the received descriptor information are identical with Class, SubClass, and Protocol of any entry of the table (Step S35: Yes), the USB device monitoring unit determines that the USB device connected to the USB port 26 can be used (Step S36).

On the other hand, when Class, SubClass, and Protocol of the received descriptor information are not identical with Class, SubClass, and Protocol of any entry of the table (Step S35: No), the USB device monitoring unit determines that the USB device connected to the USB port 26 cannot be used (Step S37).

In the present example, the USB device monitoring unit receives information including Class=0x06, SubClass=0x01, and Protocol=0x01 as descriptor information. These Class, SubClass, and Protocol of the descriptor information are identical with Class, SubClass, and Protocol of the second entry of the table (see FIG. 7). Therefore, the USB device monitoring unit determines that the USB device (the digital camera 41 in this example) connected to the USB port 26 can be used by using the digital camera print application program.

Referring to FIG. 8 again, the USB device monitoring unit informs the digital camera print application program of the effect that the digital camera 41 is connected to the USB port 26 (Step S28). In this way, after that, the digital camera print application program can perform the control on the digital camera 41 (Step S29) and print an image stored in the digital camera 41 by using the image forming apparatus 1.

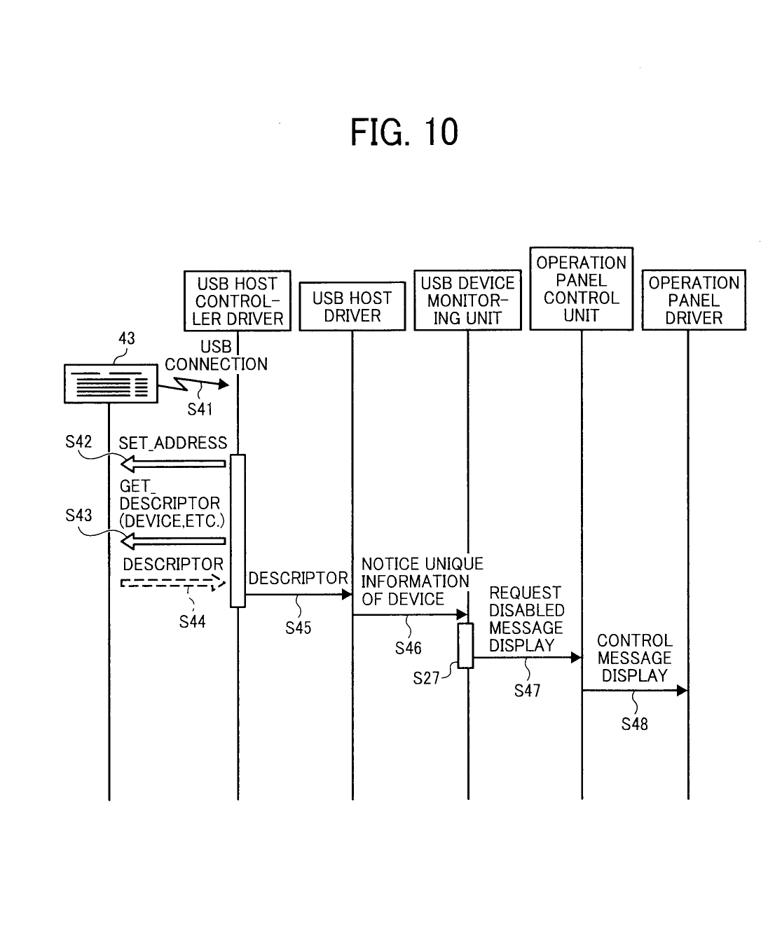

Next, it will be explained about the process of each program module when the USB keyboard 43 is connected to the USB port 26. FIG. 10 is a diagram briefly illustrating the process sequence of each program module when the USB keyboard 43 is connected to the USB port 26.

The connection of a USB device (the USB keyboard 43 in this example) to the USB port 26 is detected by the USB host controller 25, and then the connection is notified to the USB host controller driver (Step S41). Furthermore, the connection is notified to the USB device monitoring unit via the USB host driver. In order to acquire descriptor information stored in the USB device, the USB host controller 25 transmits device requests called SET_ADDRESS and GET_DESCRIPTOR to the USB device (Steps S42 and S43).

As a response to these device requests, the USB device transmits the descriptor information (including Class=0x03, SubClass=0x00, and Protocol=0x01 in this example) to the USB host controller 25, and the USB host controller 25 transmits the descriptor information to the USB host controller driver (Step S44). The USB host controller driver transmits the descriptor information to the USB host driver (Step S45), and the USB host driver transmits the descriptor information (unique information of device) to the USB device monitoring unit (Step S46).

Referring to FIG. 9 again, the USB device monitoring unit waits that the effect that the connection of the USB device is detected is notified (Step S31). If the effect that the connection of the USB device is detected is not notified (Step S32: No), the USB device monitoring unit continues waiting.

If the effect that the connection of the USB device is detected is notified (Step S32: Yes), the USB device monitoring unit receives the descriptor information of the USB device via the USB host driver and the USB host controller driver (Step S33).

Then, the USB device monitoring unit compares Class, SubClass, and Protocol of the received descriptor information with Class, SubClass, and Protocol of each entry of the table (see FIG. 7) (Step S34). When Class, SubClass, and Protocol of the received descriptor information are identical with Class, SubClass, and Protocol of any entry of the table (Step S35: Yes), the USB device monitoring unit determines that the USB device connected to the USB port 26 can be used (Step S36).

On the other hand, when Class, SubClass, and Protocol of the received descriptor information are not identical with Class, SubClass, and Protocol of any entry of the table (Step S35: No), the USB device monitoring unit determines that the USB device connected to the USB port 26 cannot be used (Step S37).

In the present example, the USB device monitoring unit receives information including Class=0x03, SubClass=0x00, and Protocol=0x01 as descriptor information. These Class, SubClass, and Protocol of the descriptor information are not identical with Class, SubClass, and Protocol of any entry of the table (see FIG. 7). Therefore, because an application program using the USB device (the USB keyboard 43 in this example) connected to the USB port 26 is not present, the USB device monitoring unit determines that the USB device connected to the USB port 26 cannot be used.

Referring to FIG. 10 again, the USB device monitoring unit requires the operation panel control unit to display the message of the effect that the USB device (the USB keyboard 43 in this example) connected to the USB port 26 cannot be used (Step S47). The operation panel control unit controls an operation panel driver so as to display the message of the effect that the USB device connected to the USB port 26 cannot be used (Step S48). In this way, the message of the effect that the USB device connected to the USB port 26 cannot be used is displayed on the operation panel 4. The user can know that the USB device connected to the USB port 26 cannot be used.

Next, it will be explained about a process of each program module when the card 31 is inserted into the card slot 27 and the digital camera 41 is connected to the USB port 26 and a process of each program module when the card 31 is not inserted into the card slot 27 and the digital camera 41 is connected to the USB port 26.

First, it will be explained about a process of each program module when the card 31 is inserted into the card slot 27 and the digital camera 41 is connected to the USB port 26.

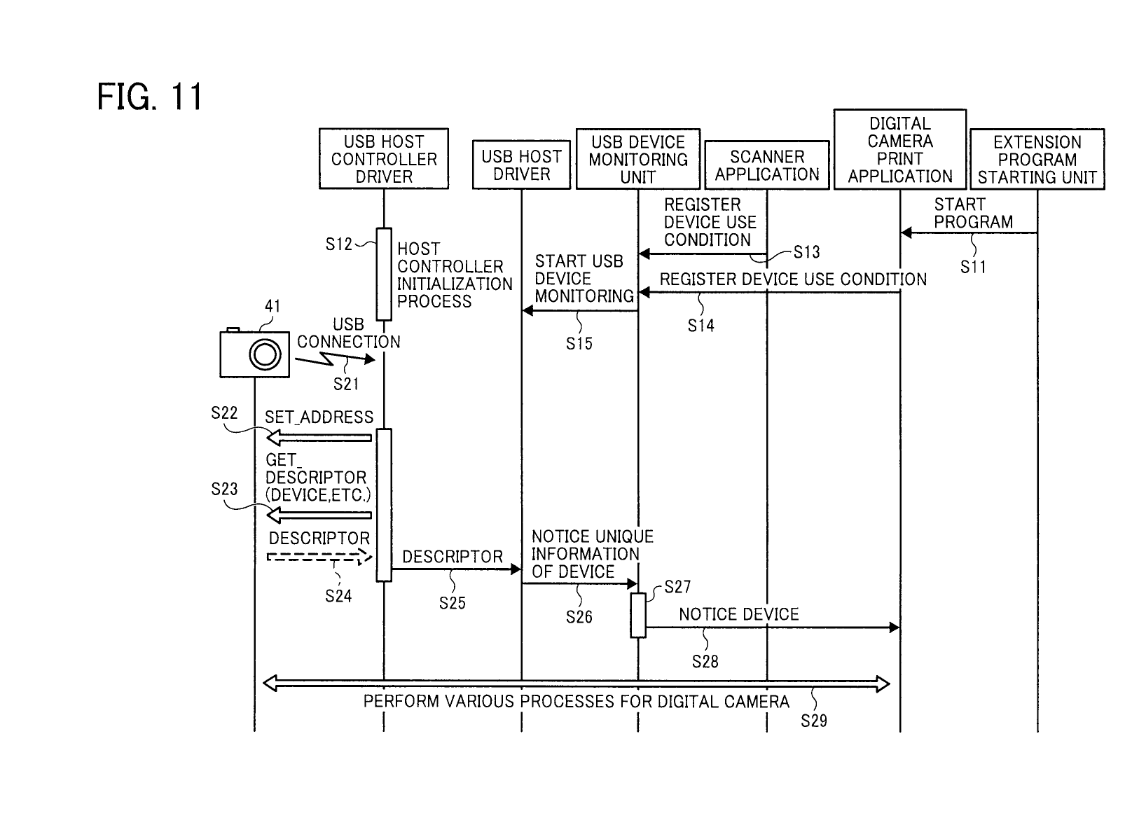

FIG. 11 is a diagram briefly illustrating the process sequence of each program module when the card 31 is inserted into the card slot 27 and the digital camera 41 is connected to the USB port 26. FIG. 11 is a diagram that is obtained by combining FIGS. 6 and 8 illustrated above. The contents are the same as those explained in FIGS. 6 and 8.

Next, it will be explained about a process of each program module when the card 31 is not inserted into the card slot 27 and the digital camera 41 is connected to the USB port 26.

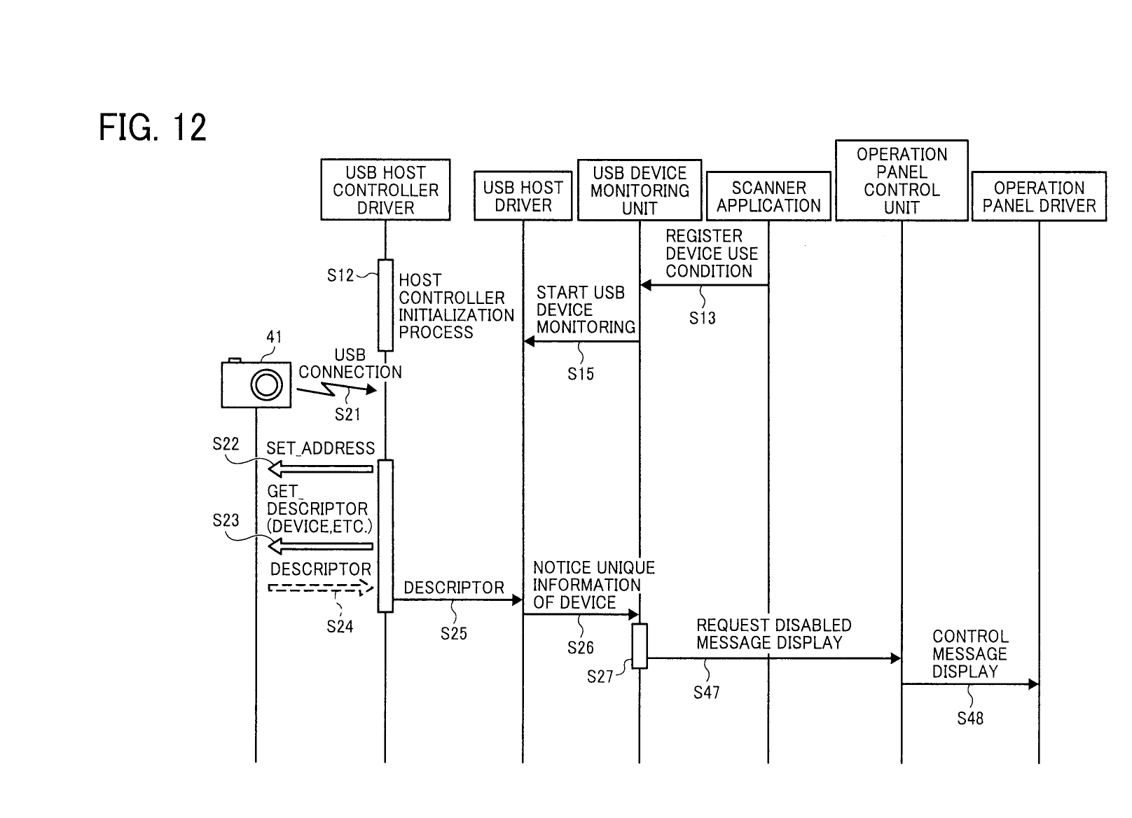

FIG. 12 is a diagram briefly illustrating the process sequence of each program module when the card 31 is not inserted into the card slot 27 and the digital camera 41 is connected to the USB port 26. When the card 31 is not inserted into the card slot 27, the digital camera print application program is not executed (started).

Referring to FIG. 12, the USB host controller driver executes an initialization process required for hardware (the USB host controller 25) (Step S12). The scanner application program registers the condition of a controllable USB device in the USB device monitoring unit (Step S13). In the present embodiment, the scanner application program informs (registers) the USB device monitoring unit of the condition (Class=0x08, SubClass=0x06, and Protocol=0x80) that accords with the USB memory.

The USB device monitoring unit starts monitoring the connection of the USB device to the USB port 26 via the USB host driver (and the USB host controller driver) (Step S15).

The connection of the USB device (the digital camera 41 in this example) to the USB port 26 is detected by the USB host controller 25 and is notified to the USB host controller driver (Step S21). Furthermore, the connection is notified to the USB device monitoring unit via the USB host driver. In order to acquire descriptor information stored in the USB device, the USB host controller 25 transmits device requests called SET_ADDRESS and GET_DESCRIPTOR to the USB device (Steps S22 and S23).

As a response to these device requests, the USB device transmits descriptor information (including Class=0x06, SubClass=0x01, and Protocol=0x01 in this example) to the USB host controller 25 and the USB host controller 25 transmits descriptor information to the USB host controller driver (Step S24). The USB host controller driver transmits descriptor information to the USB host driver (Step S25) and the USB host driver transmits descriptor information (unique information of device) to the USB device monitoring unit (Step S26).

The USB device monitoring unit executes the process illustrated in FIG. 9 that has been explained above (Step S27), and determines that the USB device (the digital camera 41 in this example) connected to the USB port 26 cannot be used.

Then, the USB device monitoring unit requires the operation panel control unit to display the message of the effect that the USB device (the digital camera 41 in this example) connected to the USB port 26 cannot be used (Step S47). The operation panel control unit controls the operation panel driver so as to display the message of the effect that the USB device connected to the USB port 26 cannot be used (Step S48). In this way, the message of the effect that the USB device connected to the USB port 26 cannot be used is displayed on the operation panel 4. The user can know that the USB device connected to the USB port 26 cannot be used.

As described above, according to the present embodiment, even if the card 31 in which the extension program (the digital camera print application program in the present embodiment) is recorded can be easily attached or detached, the determination of whether an external extension device (USB device in the present embodiment) connected by a general-purpose interface (USB in the present embodiment) can be used can be easily performed and an image forming apparatus that satisfies expandability and usability of device can be realized.

According to the present embodiment, the determination of whether a USB device is used can be dynamically performed in accordance with the presence or absence of the card 31 without rewriting or adding a system program (system software).

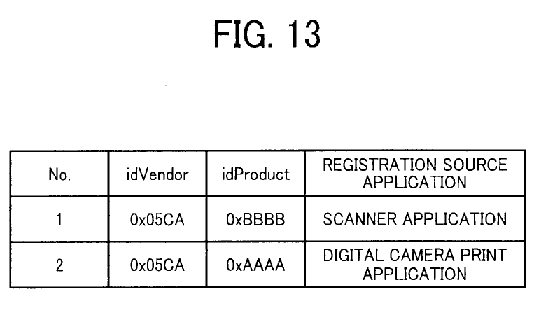

In the present embodiment, the scanner application program and the digital camera print application program register Class, SubClass, and Protocol in the table (see FIG. 7) of the USB device monitoring unit and the USB device monitoring unit compares Class, SubClass, and Protocol of the descriptor information acquired from the USB device with Class, SubClass, and Protocol registered in the table. However, different information can be utilized in place of Class, SubClass, and Protocol. As described above, a vendor ID (idVendor) that is the manufacturer identifier of the USB device and a product ID (idProduct) that is the product identifier of the USB device are included in the standard device descriptor of USB. Therefore, the scanner application program and the digital camera print application program can register the vendor ID (idVendor) and the product ID (idProduct) in the table of the USB device monitoring unit. FIG. 13 is a diagram illustrating the example of a table in which a vendor ID (idVendor) and a product ID (idProduct) are registered in place of Class, SubClass, and Protocol. In this case, the USB device monitoring unit compares the vendor ID (idVendor) and the product ID (idProduct) of the descriptor information acquired from the USB device with the vendor ID (idVendor) and the product ID (idProduct) registered in the table.

As a result, even if the card 31 in which an extension program is recorded can be easily attached or detached, the determination of whether an external extension device (USB device) connected by USB (Universal Serial Bus) can be used can be easily performed and an image forming apparatus that satisfies expandability and usability of device can be realized.

In the present embodiment, USB (Universal Serial Bus) is used as a general-purpose interface that connects an external device. However, in the present invention, an interface for connecting an external device is not limited to USB. A USB device holds descriptor information determined in a USB specification. In the present embodiment, a part (or the whole) of the descriptor information is utilized as function information peculiar to an external device. PCI (Peripheral Component Interconnect) is given as an example of an interface similar to USB. A PCI device holds information related to a device type on a register space determined in a PCI specification. A PCI device connected via a PCI bus can be also controlled similarly to the USB device described above by utilizing the register information as function information peculiar to an external device (PCI device).

A second embodiment of the present invention will be explained below. Because the block configuration and program module configuration of the image forming apparatus according to the present embodiment are similar to the block configuration (see FIG. 1) and program module configuration (see FIGS. 2, 3, and 5) of the image forming apparatus 1 according to the first embodiment explained above, their descriptions are omitted.

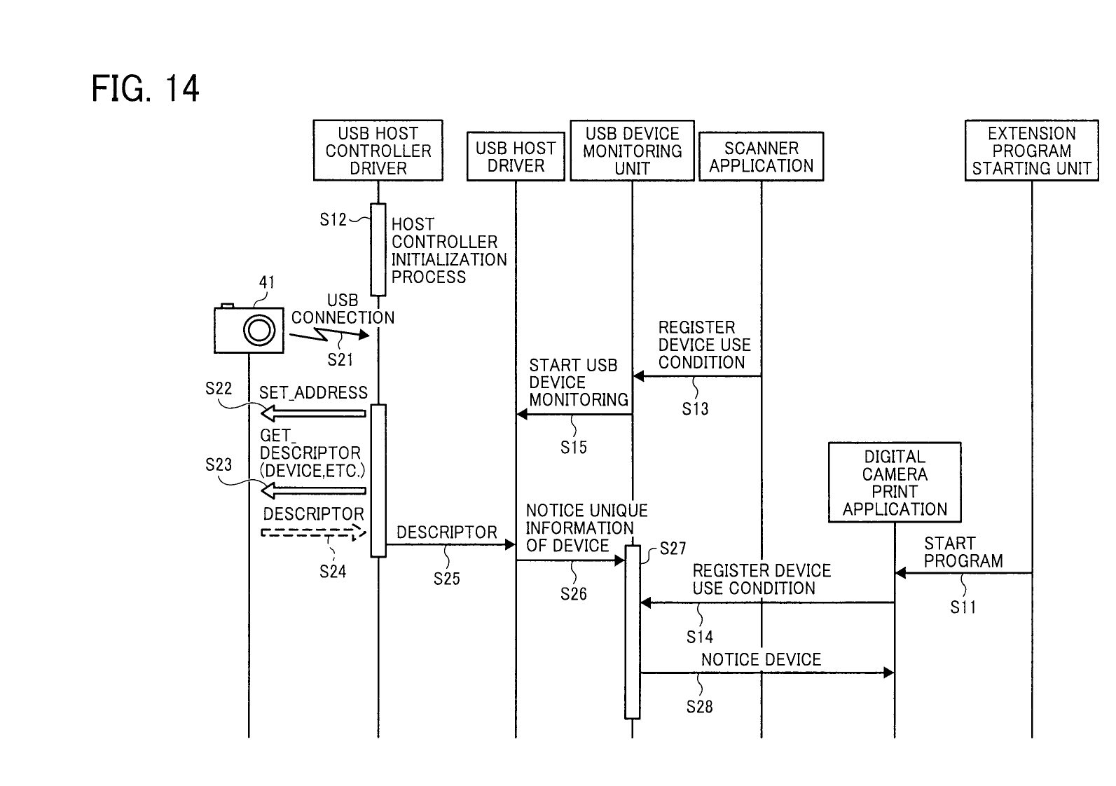

FIG. 14 is a diagram briefly illustrating the process sequence of each program module when the card 31 is inserted into the card slot 27 and the digital camera 41 is connected to the USB port 26.

Referring to FIG. 14, each module (driver, USB device monitoring unit, extension program starting unit, scanner application program, and the like) included in the system program is executed (started) by the CPU 21 at the start of the system program.

The USB host controller driver executes an initialization process required for hardware (the USB host controller 25) (Step S12).

The scanner application program registers the condition of the controllable USB device in the USB device monitoring unit (Step S13). In the present embodiment, the scanner application program is a program that can control the USB memory and informs (registers) the USB device monitoring unit of the condition (Class=0x08, SubClass=0x06, and Protocol=0x80) that accords with the USB memory.

The USB device monitoring unit starts monitoring the connection of the USB device to the USB port 26 via the USB host driver (and the USB host controller driver) (Step S15).

The connection of the USB device (the digital camera 41 in this example) to the USB port 26 is detected by the USB host controller 25 and is notified to the USB host controller driver (Step S21). Furthermore, the connection is notified to the USB device monitoring unit via the USB host driver. In order to acquire descriptor information stored in the USB device, the USB host controller 25 transmits device requests called SET_ADDRESS and GET_DESCRIPTOR to the USB device (Steps S22 and S23).

As a response to these device requests, the USB device transmits descriptor information (including Class=0x06, SubClass=0x01, and Protocol=0x01 in this example) to the USB host controller 25 and the USB host controller 25 transmits the descriptor information to the USB host controller driver (Step S24). The USB host controller driver transmits the descriptor information to the USB host driver (Step S25) and the USB host driver transmits descriptor information (unique information of device) to the USB device monitoring unit (Step S26).

The USB device monitoring unit receives information including Class=0x06, SubClass=0x01, and Protocol=0x01 as descriptor information (Step S27). However, at this time point, the condition of the USB device (the digital camera 41) that can be controlled by the digital camera print application program is not registered in the USB device monitoring unit. Therefore, the USB device monitoring unit promptly does not determine that the USB device (the digital camera 41 in this example) connected to the USB port 26 cannot be used and waits for a predetermined time (for example, one minute).

After that, when the digital camera print application program stored in the card 31 is started by the extension program starting unit (Step S11), the digital camera print application program registers the condition of the controllable USB device in the USB device monitoring unit (Step S14). In the present embodiment, the digital camera print application program is a program that can control the digital camera defined as an image device and informs (registers) the USB device monitoring unit of the condition that accords with the image device (Class=0x06, SubClass=0x01, and Protocol=0x01).

The USB device monitoring unit receives information including Class=0x06, SubClass=0x01, and Protocol=0x01 from the USB host driver as descriptor information (Step S26). These Class, SubClass, and Protocol of the descriptor information are identical with Class, SubClass, and Protocol registered by the digital camera print application program. Therefore, the USB device monitoring unit determines that the USB device (the digital camera 41 in this example) connected to the USB port 26 can be used by the digital camera print application program, and informs the digital camera print application program of the effect that the digital camera 41 is connected to the USB port 26 (Step S28).

As described above, according to the present embodiment, before the condition of the controllable digital camera 41 is registered by the digital camera print application program, even if the notice of the effect that the digital camera 41 is connected and the descriptor information of the digital camera 41 are received, the image forming apparatus promptly does not inform a user of the effect that the digital camera 41 cannot be used and waits for a predetermined time. After that, when the condition of the controllable digital camera 41 is registered by the digital camera print application program, the image forming apparatus informs the digital camera print application program of the effect that the digital camera 41 is connected. As a result, at the start of device (at an initialization process), it is possible to prevent incorrect notice (the notice of the effect that the digital camera 41 cannot be used) and to get rid of giving misunderstanding to the user.

A third embodiment of the present invention will be explained below. Because the block configuration of an image forming apparatus according to the present embodiment is similar to the block configuration (see FIG. 1) of the image forming apparatus 1 according to the first embodiment explained above, their descriptions are omitted.

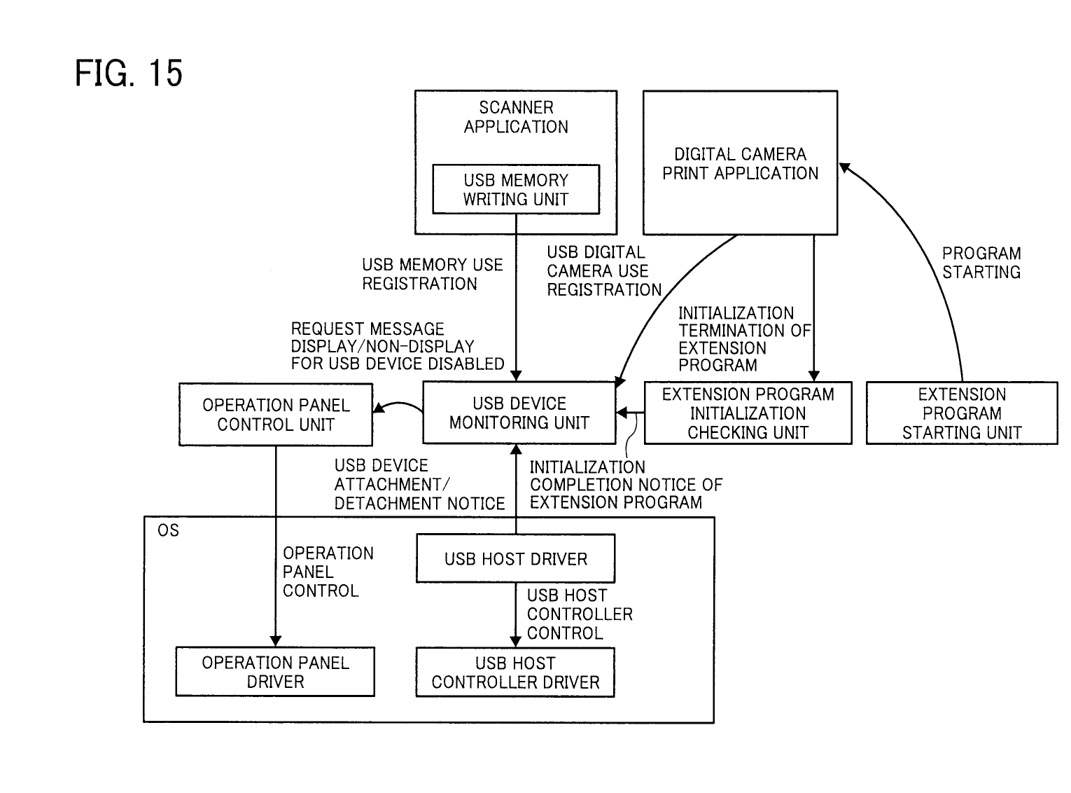

FIG. 15 is a diagram briefly illustrating a cooperation relationship between program modules according to the third embodiment. In the third embodiment, an extension program (extension software) initialization checking unit is added compared to the first embodiment (see FIG. 5) explained above. The extension program (extension software) initialization checking unit is implemented to be included as a part of SCS illustrated in FIG. 2.

The extension program initialization checking unit checks all external recording medium connection slots such as the card slot 27 (see FIG. 1). When initialization processes for all extension programs are completed, the extension program initialization checking unit informs the USB device monitoring unit of the effect that the initialization processes for all extension programs are completed.

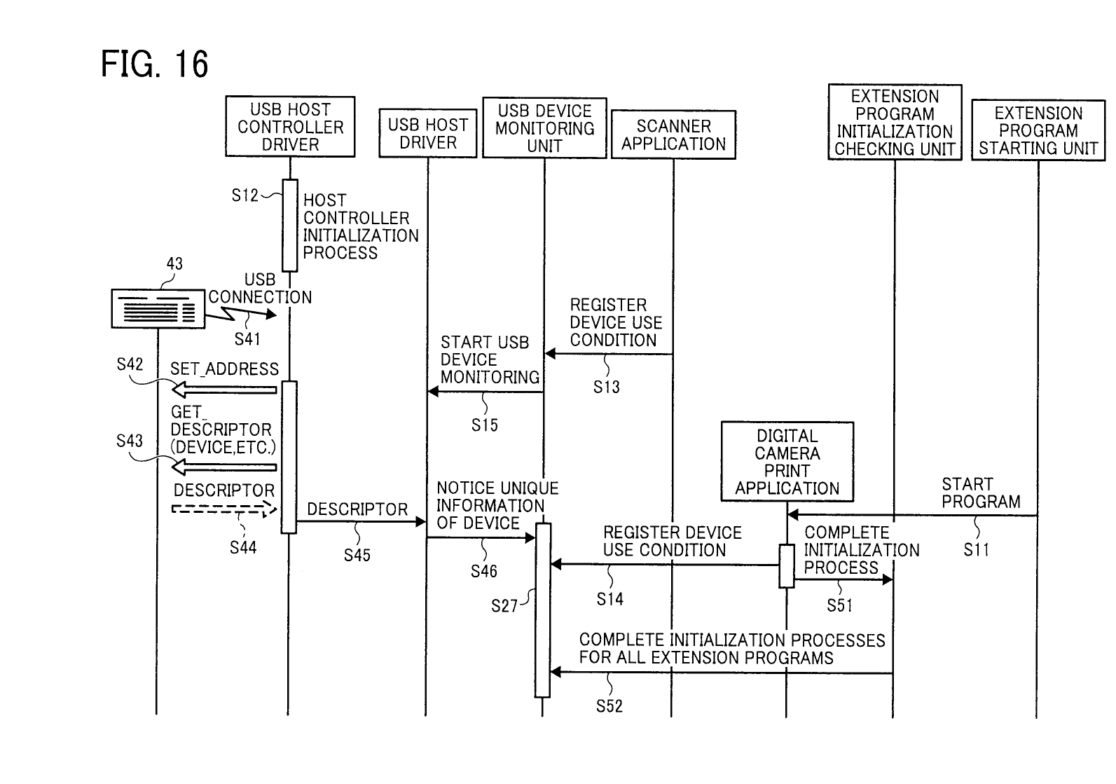

FIG. 16 is a diagram briefly illustrating the process sequence of each startup program module in the present embodiment. In this case, the USB keyboard 43 acting as a USB device is connected to the USB port 26 (see FIG. 1).

As illustrated in FIG. 16, when an extension program (digital camera print application program) is started by the extension program starting unit (Step S11), the extension program registers the condition of the usable USB device (Class=0x06, SubClass=0x01, and Protocol=0x01 in this example) in the USB device monitoring unit as a part of an initialization process at starting (Step S14). Furthermore, when the initialization process is completed, the extension program informs the extension program initialization checking unit of the effect that the initialization process is completed (Step S51). When confirming that initialization processes for all extension programs of all external slots are completed, the extension program initialization checking unit informs the USB device monitoring unit of the effect that the initialization processes for all extension programs are completed (Step S52).

When the USB device monitoring unit receives the notice of the effect that the initialization processes for all extension programs are completed from the extension program initialization checking unit, the USB device monitoring unit causes the operation panel control unit to display a message indicative of the effect (see FIG. 15) when it is determined that the USB device (the USB keyboard 43 in this example) cannot be used. As a result, the effect that the USB keyboard 43 cannot be used is notified by the operation panel 4 to the user.

On the other hand, when the USB device monitoring unit receives the notice of the effect that the initialization processes for all extension programs are completed from the extension program initialization checking unit, the USB device monitoring unit informs an application program that can use a USB device of the effect that the USB device is connected when it is determined that the USB device can be used. As a result, the application program can use the USB device.

In the second embodiment explained above, the USB device monitoring unit waits for a predetermined time (for example, one minute). Therefore, according to the second embodiment, the USB device monitoring unit waits for a predetermined time even if the initialization processes for all extension programs are completed within the predetermined time.

On the other hand, according to the present embodiment, when the USB device monitoring unit receives the notice of the effect that the initialization processes for all extension programs are completed, the USB device monitoring unit requests the display of a message for informing the user of the effect when it is determined that the USB device cannot be used. The USB device monitoring unit informs the application program that can use the USB device of the effect that the USB device is connected when it is determined that the USB device can be used. Therefore, an unnecessary waiting time can be omitted. The effect that the USB device cannot be used can be notified to the user or the connection of USB device can be notified to the application program when a required minimum period ends (when initialization processes for all extension programs are completed). As a result, it is possible to raise system responsiveness.

In addition, a program control program executed in the image forming apparatus according to the embodiment of the present invention is previously incorporated and provided in the ROM 24.

The program control program executed in the image forming apparatus according to the embodiment of the present invention can be configured to be recorded and provided in a computer-readable recording medium such as CD-ROM, FD (flexible disk), CD-R, or DVD (digital versatile disk) in the format of file that can be installed or executed.

Furthermore, a program control program executed in the image forming apparatus according to the embodiment of the present invention can be stored in a computer connected to a network such as Internet and be provided by being downloaded through the network. Moreover, a program control program executed in the image forming apparatus according to the embodiment of the present invention can be provided or distributed through a network such as Internet.

A program control program executed in the image forming apparatus according to the embodiment of the present invention has a module configuration including the above components (the OS (including the driver group), the service group (including the USB device monitoring unit, the operation panel control unit, the extension program starting unit, and the extension program initialization checking unit), the printer application program, the scanner application program, the copy application program, and the facsimile application program). As actual hardware, the CPU (processor) reads out and executes the program control program from the ROM and thus the components are loaded on the main memory. As a result, the OS (including the driver group), the service group (including the USB device monitoring unit, the operation panel control unit, the extension program starting unit, and the extension program initialization checking unit), the printer application program, the scanner application program, the copy application program, and the facsimile application program are generated on the main memory.

In the embodiment of the present invention, there has been explained about an example of applying the image forming apparatus of the present invention to a multifunction product having at least two functions among a copy function, a printer function, a scanner function, and a facsimile function. However, the image forming apparatus can be applied to any of a copy machine, a printer, a scanner, and a facsimile machine.

As described above, according to one aspect of the present invention, even if it is difficult to rewrite or add a system program, it can be dynamically determined whether an external device can be used or not.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
an external recording medium connecting unit configured to be connected to an external recording medium;
an external device connecting unit configured to be connected to a plurality of types of external devices with a predetermined interface;
a program starting unit that starts a program stored in an external recording medium connected to the external recording medium connecting unit;
an external device connection detecting unit that detects a connection of an external device to the external device connecting unit;
a first information acquiring unit that acquires, when the external device connection detecting unit detects the connection of the external device to the external device connecting unit, first information related to the external device connected to the external device connecting unit;
a second information acquiring unit that acquires second information related to an external device that can be utilized by executing the program;
a determining unit that determines whether the external device connected to the external device connecting unit can be utilized, by comparing the first information and the second information;
a control unit that controls, when the determining unit determines that the external device connected to the external device connecting unit can be utilized, the external device connected to the external device connecting unit; and
an informing unit that informs, when the determining unit determines that the external device connected to the external device connecting unit cannot be utilized, that the external device cannot be utilized to a user.

2. The information processing apparatus according to claim 1, wherein
the predetermined interface is a universal serial bus, and
the first information and the second information are a part or whole of descriptor information defined in universal serial bus specifications.

3. A program control method for an information processing apparatus that includes an external recording medium connecting unit configured to be connected to an external recording medium and an external device connecting unit configured to be connected to a plurality of types of external devices with a predetermined interface, the program control method comprising:
starting a program recorded in an external recording medium connected to the external recording medium connecting unit;
detecting a connection of an external device to the external device connecting unit;
first acquiring including acquiring, when the connection of the external device to the external device connecting unit is detected at the detecting, first information related to the external device connected to the external device connecting unit;
second acquiring including acquiring second information related to an external device that can be utilized by executing the program;
determining whether the external device connected to the external device connecting unit can be utilized by comparing the first information and the second information;
controlling, when it is determined that the external device connected to the external device connecting unit can be utilized, the external device connected to the external device connecting unit; and
first informing including informing, when it is determined that the external device connected to the external device connecting unit cannot be utilized, that the external device cannot be utilized to a user.

4. The program control method according to claim 3, wherein
the predetermined interface is a universal serial bus, and
the first information and the second information are a part or whole of descriptor information defined in universal serial bus specifications.

5. The program control method according to claim 3, wherein the determining includes
waiting for a predetermined time, when the first information is acquired at the first acquiring but the second information is not acquired at the second acquiring,
determining whether the external device connected to the external device connecting unit can be utilized, when the second information is acquired at the second acquiring within the predetermined time, by comparing the first information and the second information, and
determining that the external device cannot be utilized, when the second information is not acquired at the second acquiring within the predetermined time.

6. The program control method according to claim 4, wherein the determining includes
waiting for a predetermined time, when the first information is acquired at the first acquiring but the second information is not acquired at the second acquiring,
determining whether the external device connected to the external device connecting unit can be utilized, when the second information is acquired at the second acquiring within the predetermined time, by comparing the first information and the second information, and
determining that the external device cannot be utilized, when the second information is not acquired at the second acquiring within the predetermined time.

7. The program control method according to claim 3, further comprising second informing including informing, when an initialization of the program started at the starting is completed, a completion of the initialization of the program to the determining, wherein
the determining includes
waiting a notice from the second informing, when the first information is acquired at the first acquiring but the second information is not acquired at the second acquiring,
determining whether the external device connected to the external device connecting unit can be utilized, when the second information is acquired at the second acquiring until the notice is received from the second informing, by comparing the first information and the second information, and
determining that the external device cannot be utilized, when the second information is not acquired at the second acquiring at the time of receiving the notice from the second informing.

8. The program control method according to claim 4, further comprising second informing including informing, when an initialization of the program started at the starting is completed, a completion of the initialization of the program to the determining, wherein
the determining includes
waiting a notice from the second informing, when the first information is acquired at the first acquiring but the second information is not acquired at the second acquiring,
determining whether the external device connected to the external device connecting unit can be utilized, when the second information is acquired at the second acquiring until the notice is received from the second informing, by comparing the first information and the second information, and
determining that the external device cannot be utilized, when the second information is not acquired at the second acquiring at the time of receiving the notice from the second informing.

9. A computer program product comprising a computer-usable medium having computer-readable program codes embodied in the medium for implementing a program control method for an information processing apparatus that includes an external recording medium connecting unit configured to be connected to an external recording medium and an external device connecting unit configured to be connected to a plurality of types of external devices with a predetermined interface, the program codes when executed causing a computer to execute:
starting a program recorded in an external recording medium connected to the external recording medium connecting unit;
detecting a connection of an external device to the external device connecting unit;
first acquiring including acquiring, when the connection of the external device to the external device connecting unit is detected at the detecting, first information related to the external device connected to the external device connecting unit;
second acquiring including acquiring second information related to an external device that can be utilized by executing the program;
determining whether the external device connected to the external device connecting unit can be utilized by comparing the first information and the second information;
controlling, when it is determined that the external device connected to the external device connecting unit can be utilized, the external device connected to the external device connecting unit; and
first informing including informing, when it is determined that the external device connected to the external device connecting unit cannot be utilized, that the external device cannot be utilized to a user.

10. The computer program product according to claim 9, wherein
the predetermined interface is a universal serial bus, and
the first information and the second information are a part or whole of descriptor information defined in universal serial bus specifications.

11. The computer program product according to claim 9, wherein the determining includes
waiting for a predetermined time, when the first information is acquired at the first acquiring but the second information is not acquired at the second acquiring,
determining whether the external device connected to the external device connecting unit can be utilized, when the second information is acquired at the second acquiring within the predetermined time, by comparing the first information and the second information, and
determining that the external device cannot be utilized, when the second information is not acquired at the second acquiring within the predetermined time.

12. The computer program product according to claim 10, wherein the determining includes
waiting for a predetermined time, when the first information is acquired at the first acquiring but the second information is not acquired at the second acquiring,
determining whether the external device connected to the external device connecting unit can be utilized, when the second information is acquired at the second acquiring within the predetermined time, by comparing the first information and the second information, and
determining that the external device cannot be utilized, when the second information is not acquired at the second acquiring within the predetermined time.

13. The computer program product according to claim 9, wherein the program codes further causes the computer to execute second informing including informing, when an initialization of the program started at the starting is completed, a completion of the initialization of the program to the determining, wherein
the determining includes
waiting a notice from the second informing, when the first information is acquired at the first acquiring but the second information is not acquired at the second acquiring,
determining whether the external device connected to the external device connecting unit can be utilized, when the second information is acquired at the second acquiring until the notice is received from the second informing, by comparing the first information and the second information, and
determining that the external device cannot be utilized, when the second information is not acquired at the second acquiring at the time of receiving the notice from the second informing.

14. The computer program product according to claim 10, wherein the program codes further cause the computer to execute second informing including informing, when an initialization of the program started at the starting is completed, a completion of the initialization of the program to the determining, wherein
the determining includes
waiting a notice from the second informing, when the first information is acquired at the first acquiring but the second information is not acquired at the second acquiring,
determining whether the external device connected to the external device connecting unit can be utilized, when the second information is acquired at the second acquiring until the notice is received from the second informing, by comparing the first information and the second information, and
determining that the external device cannot be utilized, when the second information is not acquired at the second acquiring at the time of receiving the notice from the second informing.
